(19) United States
(12) Patent Application Publication
(10) Pub. No.: US 2026/0233962 A1
(43) Pub. Date: Aug. 13, 2026

(54) WIRE BUFFER SYSTEM

(71) Applicant: GM Global Technology Operations LLC, Detroit, MI (US)

(72) Inventor: Kyungjin Cheon, Jeollabuk-do (KR)

(73) Assignee: GM Global Technology Operations LLC, Detroit, MI (US)

(21) Appl. No.: 19/051,793

(22) Filed: Feb. 12, 2025

(51) Int. Cl. B65H 51/20; B65H 57/14

(52) U.S. Cl. CPC B65H 51/20; B65H 57/14; B65H 2402/443; B65H 2404/743; B65H 2553/82; B65H 2555/00; B65H 2701/361

(57) ABSTRACT

A wire buffer assembly includes a frame having a top portion defining a first opening and a second opening, a guide wheel disposed within the frame, a plurality of guide pins disposed within the frame and disposed around the guide wheel, and at least one sensor disposed proximate to the guide wheel and configured to detect a position of the guide wheel within the frame.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure pertains to the preparation of wire for feeding into machinery. More specifically, it addresses the preparation of wire for feeding into automated tools, such as laser brazing tools, welding tools, or soldering tools, which utilize wire containing filler metal to join two or more pieces of base metal.

In manufacturing applications, machines often receive wire from a drum. For instance, these machines may include laser brazing tools, welding tools, or soldering tools, among other tools that utilize wire. Typically, the wire is coiled or wrapped around a spool. However, as the wire leaves the drum, it can frequently become tangled, twisted, snagged, or otherwise obstructed. These impediments can cause the machine to abruptly stop operation. Such abrupt stoppages can result in defects in the joining process, leading to the discarding of manufactured components or raw materials. Additionally, these stoppages can cause costly downtime and interruptions in manufacturing processes. Therefore, there is a need for improved processes to feed the wire from the drum to the machine, effectively removing impediments and preventing abrupt stoppages in the machine's operation.

### SUMMARY

In some aspects, a wire buffer assembly includes a frame having a top portion defining a first opening and a second opening, a guide wheel disposed within the frame, a plurality of guide pins disposed within the frame and disposed around the guide wheel, and at least one sensor disposed proximate to the guide wheel and configured to detect a position of the guide wheel within the frame.

In some examples, a motor may be disposed at the first opening. Optionally, the at least one sensor may include a first guide wheel sensor disposed proximate to a bottom portion of the frame, the first guide wheel sensor configured to detect a first position of the guide wheel defined above the first guide wheel sensor. Additionally or alternatively, the at least one sensor may include a second guide wheel sensor disposed between the first guide wheel sensor and the top portion of the frame. The second guide wheel sensor may be configured to detect a second position of the guide wheel defined between the second guide wheel sensor and the top portion of the frame. In some configurations, the at least one sensor may include a third guide wheel sensor disposed proximate to the top portion of the frame. The third guide wheel sensor may be configured to detect a third position of the guide wheel defined between the third guide wheel sensor and the top portion of the frame. In other configurations, the at least one sensor may include a wire feed sensor disposed at the top portion of the frame, and the wire feed sensor may be configured to detect a wire in the frame.

In some examples, each of the at least one sensor may include at least one of a photoelectric sensor, a Hall effect sensor, an inductive sensor, and an ultrasonic sensor. In other examples, a first panel may be coupled to the frame and a second panel may be coupled to the frame. In some configurations, the plurality of guide pins may extend from the first panel to the second panel. The guide wheel may be suspended within the frame between the first panel and the second panel, and the guide wheel may be free from direct attachment with each of the frame, the first panel, and the second panel. Optionally, the guide wheel may include a channel defined along a circumference of the guide wheel.

In other aspects, a wire buffer system includes a wire buffer assembly configured to receive a wire, the wire buffer assembly including a frame having a top portion defining a first opening and a second opening, the wire received by the frame at the first opening. A guide wheel is disposed within the frame and has a raised position and a lowered position, the wire operably coupled to the guide wheel. A motor is coupled to the frame and is disposed at the first opening. A first guide wheel sensor is disposed proximate to a bottom portion of the frame and is configured to detect one of the raised position and the lowered position of the guide wheel within the frame. The wire buffer system also includes an automated tool configured to receive the wire from the second opening of the frame, and a controller communicatively coupled with the automated tool. The controller includes data processing hardware and memory hardware in communication with the data processing hardware, the memory hardware storing instructions that when executed on the data processing hardware cause the data processing hardware to perform operations. The operations include activating the motor in response to the first guide wheel sensor detecting the guide wheel in the raised position for a first predetermined period of time, the raised position defined by the guide wheel being positioned above the first guide wheel sensor. The operations also include stopping the motor when the first guide wheel sensor detects the guide wheel in the lowered position, the lowered position defined by the guide wheel being positioned beneath the first guide wheel sensor proximate to the bottom portion of the frame for a second predetermined period of time.

In some examples, a second guide wheel sensor may be disposed between the first guide wheel sensor and the top portion of the frame. The second guide wheel sensor may be configured to detect that the guide wheel is between the second guide wheel sensor and the top portion of the frame. In other examples, the operations may include stopping the automated tool when the second guide wheel sensor detects the guide wheel between the second guide wheel sensor and the top portion of the frame. Additionally or alternatively, a third guide wheel sensor may be disposed proximate to the top portion of the frame. The third guide wheel sensor may be configured to detect that the guide wheel is between the third guide wheel sensor and the top portion of the frame. Optionally, the operations may include stopping the automated tool when the third guide wheel sensor detects that the guide wheel is between the third guide wheel sensor and the top portion of the frame.

In some configurations, a wire feed sensor may be disposed at the top portion of the frame. The wire feed sensor may be configured to detect the wire received by the frame. Optionally, the operations may include selectively activating the motor when the wire feed sensor detects the wire. In other configurations, each of the first guide wheel sensor, the second guide wheel sensor, the third guide wheel sensor, and the wire feed sensor may include at least one of a photoelectric sensor, a Hall effect sensor, an inductive sensor, and an ultrasonic sensor.

In further aspects, a wire buffer system includes a wire buffer assembly configured to receive a wire. The wire buffer assembly includes a frame having a top portion defining a first opening and a second opening, the wire received by the frame at the first opening. A guide wheel is disposed within the frame and has a raised position and a lowered position, the wire operably coupled to the guide wheel. A motor is coupled to the frame and is disposed at the first opening. A first guide wheel sensor is disposed proximate to a bottom portion of the frame, the first guide wheel sensor configured to detect one of the raised position and the lowered position of the guide wheel within the frame. A second guide wheel sensor is disposed between the first guide wheel sensor and the top portion of the frame. The second guide wheel sensor is configured to detect that the guide wheel is between the second guide wheel sensor and the top portion of the frame. A third guide wheel sensor is disposed proximate to the top portion of the frame. The third guide wheel sensor is configured to detect that the guide wheel is between the third guide wheel sensor and the top portion of the frame. A wire feed sensor is disposed at the top portion of the frame. The wire feed sensor is configured to detect the wire received by the frame. The wire buffer system further includes an automated tool configured to receive the wire from the second opening of the frame and a controller communicatively coupled with the automated tool. The controller includes data processing hardware and memory hardware in communication with the data processing hardware. The memory hardware stores instructions that when executed on the data processing hardware cause the data processing hardware to perform operations. The operations include selectively activating the motor when the wire feed sensor detects the wire. The operations also include activating the motor in response to the first guide wheel sensor detecting the guide wheel in the raised position for a first predetermined period of time, the raised position defined by the guide wheel being positioned above the first guide wheel sensor. The operations further include stopping the motor when the first guide wheel sensor detects the guide wheel in the lowered position, the lowered position defined by the guide wheel being positioned beneath the first guide wheel sensor proximate to the bottom portion of the frame for a second predetermined period of time. The operations additionally include stopping the automated tool when the second guide wheel sensor detects the guide wheel between the second guide wheel sensor and the top portion of the frame. The operations also include stopping the automated tool when the third guide wheel sensor detects that the guide wheel is between the third guide wheel sensor and the top portion of the frame.

### BRIEF DESCRIPTION OF THE DRAWINGS

The drawings described herein are for illustrative purposes only of selected configurations and are not intended to limit the scope of the present disclosure.

FIG. 1 is a perspective view of a wire buffer system according to the present disclosure;

FIG. 2A is a perspective view of a wire buffer assembly according to the present disclosure;

FIG. 2B is a perspective view of the wire buffer assembly of FIG. 2A, the wire buffer assembly having a front panel removed;

FIG. 3 is a cross-sectional view of a guide wheel between a first panel and a second panel of the wire buffer assembly of FIG. 2A;

FIG. 4 is a block diagram illustrating a plurality of sensors sending sensor data to a controller of a wire buffer system according to the present disclosure; and

FIGS. 5A-5C are perspective views of a wire buffer assembly according to the present disclosure, the wire buffer assembly having a guide wheel in various positions during states of operation of the wire buffer assembly.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

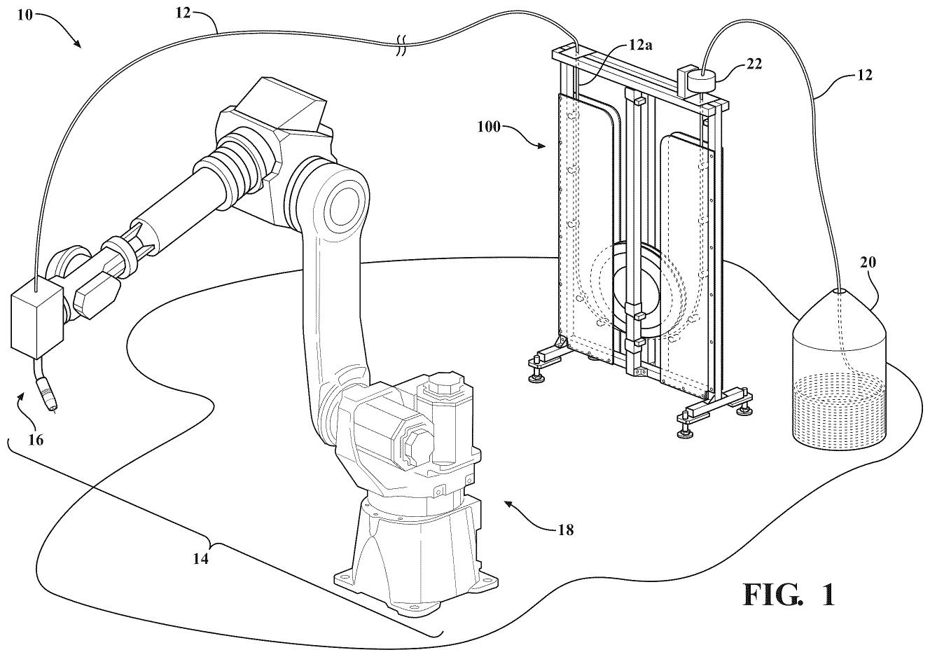

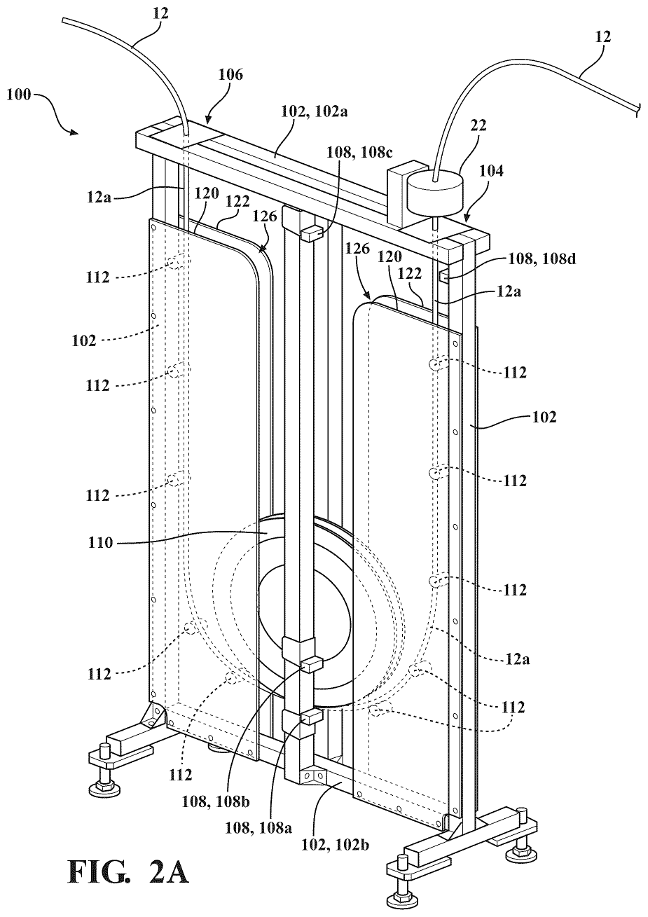

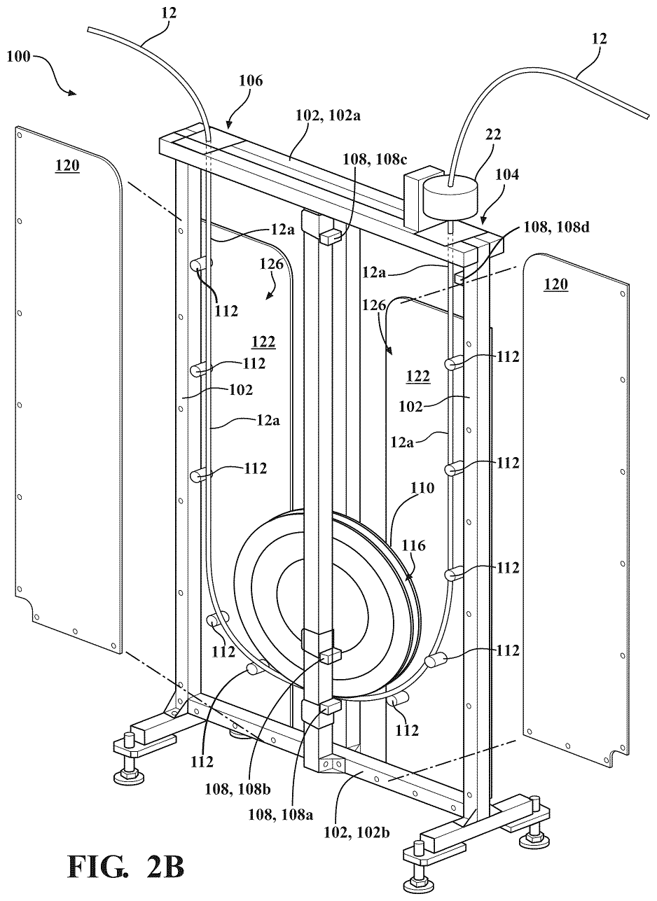

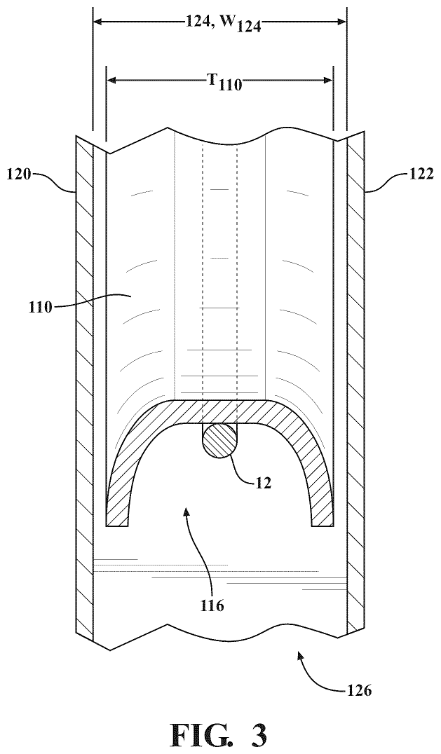

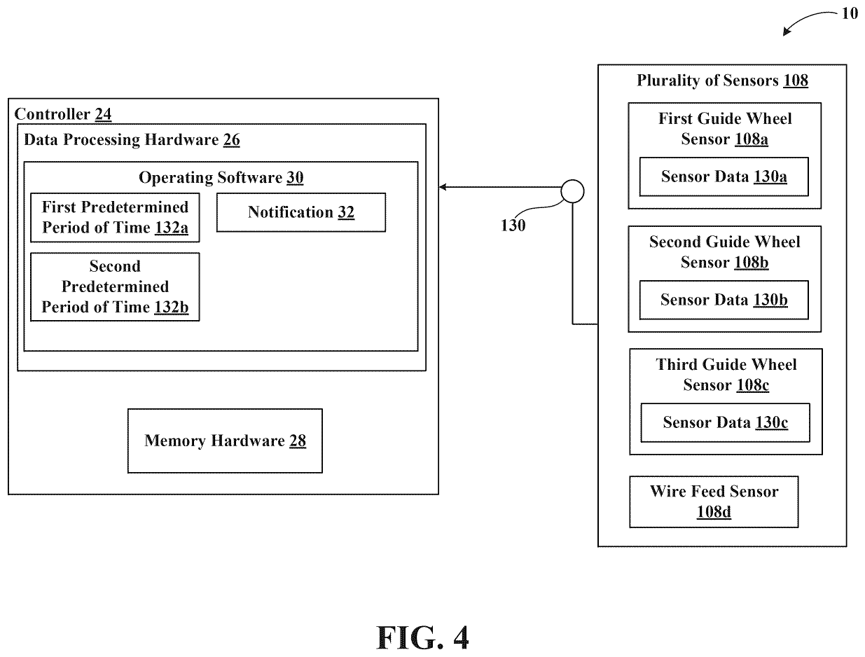

Referring to FIGS. 1-4, a wire buffer system 10 includes a wire buffer assembly 100 that provides wire 12 to an automated tool 14. The automated tool 14 may include a tool head 16, such as a laser brazing device, a welding device, or a soldering device. In some examples, the automated tool 14 may be fixed at a station or manipulated by a human operator. In the illustrated example, the automated tool 14 includes a robotic arm 18, where the robotic arm 18 manipulates the tool head 16. The wire feed buffer system 10 receives the wire 12 from a dispenser 20, such as a spool or a drum. The wire 12 withdrawn from the dispenser 20 into the wire buffer system 10 may be referred to as a wire feed. The wire 12 may be drawn into the wire buffer assembly 100 via a motor 22. For example, an initial portion of the wire 12 may be manually fed into the motor 22, which is configured to selectively draw the wire 12 into the wire buffer assembly 100 during operation of the wire buffer system 10, described in more detail below.

The wire buffer system 10 also includes a controller 24 that is communicatively coupled with the automated tool 14 and the wire buffer assembly 100, described in detail below. The controller 24 includes data processing hardware 26 and memory hardware 28 in communication with the data processing hardware 26. The memory hardware 28 stores instructions that, when executed by the data processing hardware 26, cause the data processing hardware 26 to perform operations described herein. The controller 24 may be configured to operate software 30 that is executed by the data processing hardware 26 and corresponds to the operations performed by the data processing hardware 26. The controller 24 is configured to control selective withdrawal of the wire 12 from the dispenser 20 and a speed at which the wire 12 is fed to the automated tool 14.

The wire 12 is fed from the dispenser 20 into a frame 102 of the wire buffer assembly 100 by the motor 22. For example, the motor 22 may be disposed at a top portion 102a of the frame 102. The top portion 102a of the frame 102 defines a first opening 104 and a second opening 106. The motor 22 may be positioned or otherwise coupled to the frame 102 proximate to the first opening 104, and the wire 12 is fed into the frame 102 through the first opening 104. The motor 22 may also be coupled to or positioned proximate to the dispenser 20, such that the motor 22 may be separate from the frame 102 in other configurations. The wire 12 is configured to pass through the first opening 104, through the frame 102, and exits the frame 102 at the second opening 106 toward the automated tool 14.

The wire buffer assembly 100 also includes a plurality of sensors 108 communicatively coupled with the controller 24. The plurality of sensors 108 may include, but are not limited to, at least one of a photoelectric sensor, a Hall effect sensor, an inductive sensor, or an ultrasonic sensor. The plurality of sensors 108 includes guide wheel sensors 108a-108c, described below, and a wire feed sensor 108d. The wire feed sensor 108d may be disposed along the top portion 102a of the frame 102 proximate to the first opening 104 of the frame 102. The wire feed sensor 108d is configured to detect the wire 12, as the wire 12 is fed from the dispenser 20 into the frame 102. For example, the controller 24 may activate the motor 22 to feed the wire 12 from the dispenser 20, and the wire feed sensor 108d may detect the wire 12 as the wire 12 passes through the first opening 104 into the frame 102. If the wire 12 is not detected by the wire feed sensor 108d (i.e., the wire 12 is not present or there is a failure of the wire feed sensor 108d), then the controller 24 may stop operation of the motor 22.

With further reference to FIGS. 1-4, the wire buffer assembly 100 also includes a guide wheel 110 disposed within the frame 102 and a plurality of guide pins 112 disposed within the frame 102 around the guide wheel 110. Once the wire 12 is received in the frame 102, the wire 12 passes around a portion of a circumference of the guide wheel 12. For example, the guide wheel 110 has a channel 116 defined along the circumference of the guide wheel 110. A width W116 and a shape of the channel 116 may correspond with a diameter or gauge of the wire 12. The guide wheel 110 receives the wire 12 within the channel 116 such that the wire 12 is operably coupled to the guide wheel 110. The wire 12 passes about a portion of the guide wheel 110 as the wire 12 travels from the first opening 104 to the second opening 106. The guide wheel 110 may rotate so there is minimal or otherwise negligible relative motion between the guide wheel 110 and the wire 12 within the channel 116 as the wire 12 moves about the guide wheel 110.

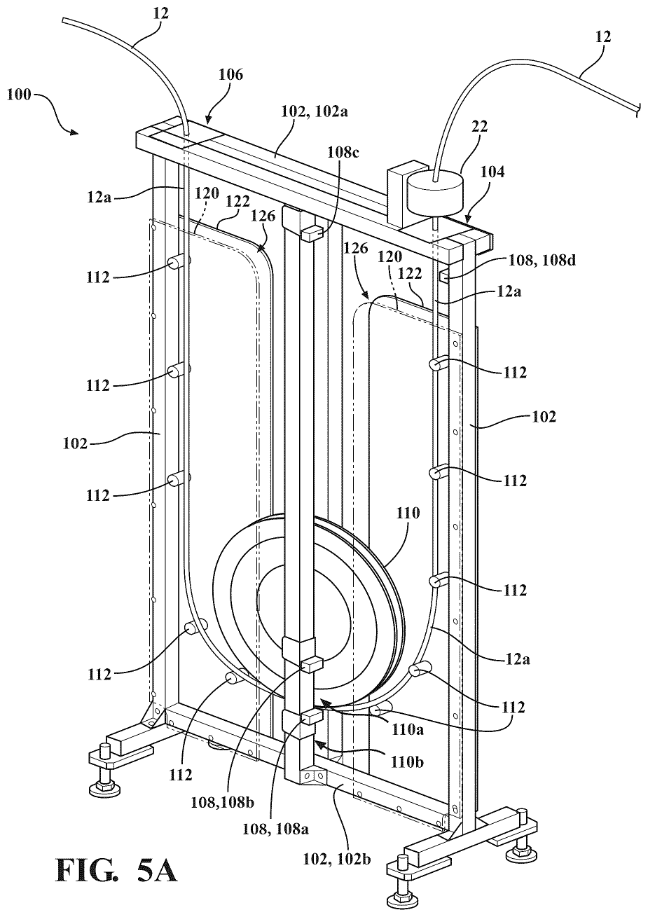

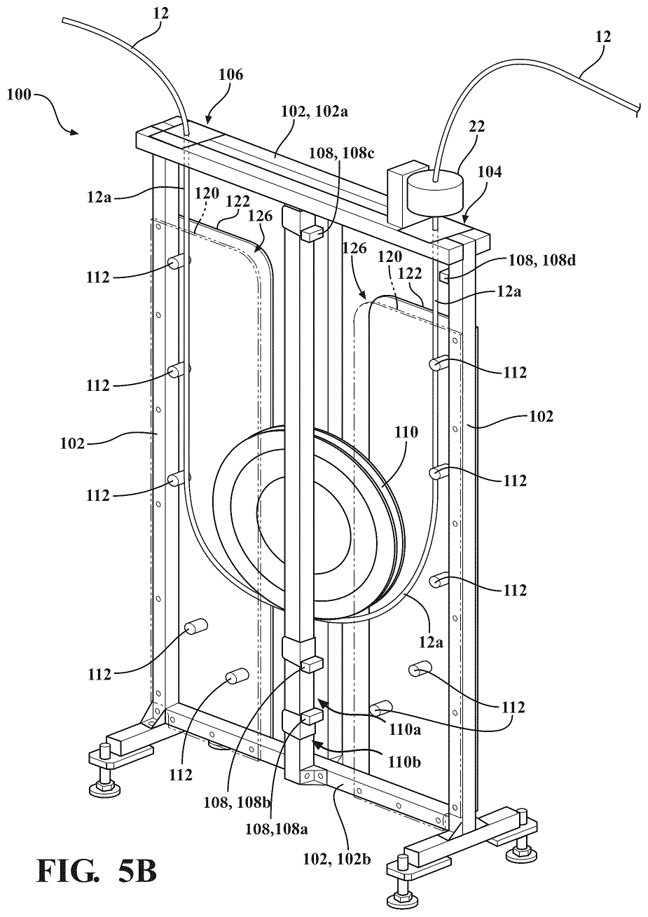

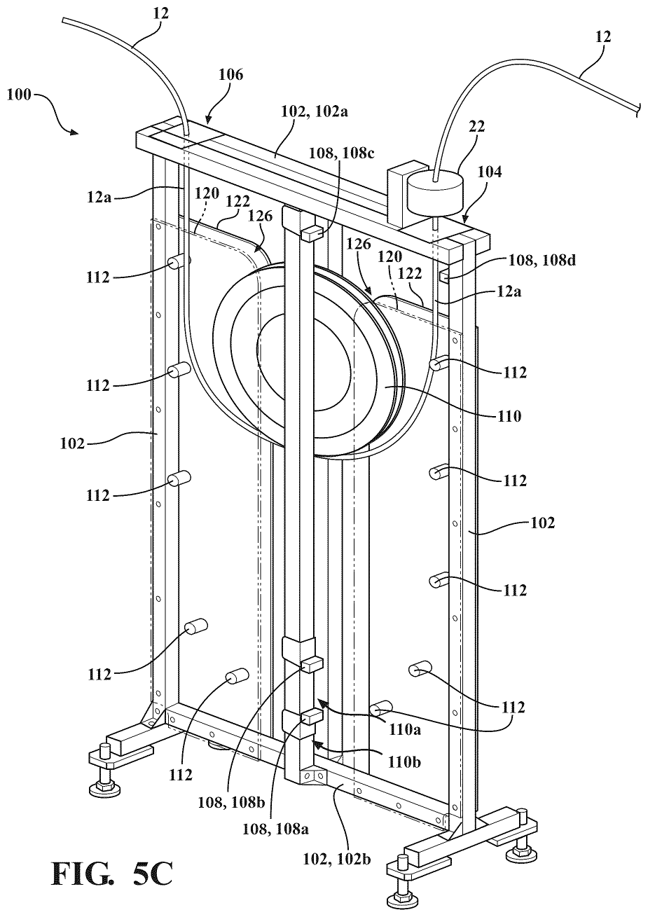

The wire buffer assembly 100 also includes a first panel 120 and a second panel 122 coupled to the frame 102. The first panel 120 and the second panel 122 may each include one panel or a plurality of panels. The panels 120, 122 may be coupled to the frame 102 via fasteners, such as screws or nuts and bolts, with adhesive, and/or any other practicable fastening mechanism. In alternative examples in which the frame 102 and the panels 120, 122 are metal, the panels 120, 122 may be coupled to the frame 102 by welding the panels 120, 122 to the frame 102. As discussed further below with respect to FIGS. 5A-5C, the guide wheel 110 is suspended within the frame 102 between the first panel 120 and the second panel 122, such that the guide wheel 110 is free from direct attachment with each of the frame 102, the first panel 120, and the second panel 122. For example, the guide wheel 110 is disposed within the frame 102 between the first and second panels 120, 122 while remaining unattached or otherwise free from direct coupling with the panels 120, 122 and the frame 102. As described in more detail below, the guide wheel 110 is suspended via the wire 12. The wire 12 is fed into the frame 102 and disposed along at least a portion of the guide wheel 110 within the bounds of the guide pins 112. The guide pins 112 generally surround the guide wheel 110 and extend from the first panel 120 to the second panel 122. The guide pins 112 may also restrict movement of the guide wheel 110 within the frame 102 while providing a wire path 12a for the wire 12. For example, the guide pins 112 proximate to the bottom portion 102b of the frame 102 may optionally support the guide wheel 110 when the guide wheel 110 is disposed near the bottom portion 102b of the frame 102.

The first panel 120 and the second panel 122 are separated by a distance 124 having a width W124 greater than a thickness T110 of the guide wheel 110. The distance 124 is great enough to provide clearance for the guide wheel 110 while containing the guide wheel 110 within a space 126 defined by the frame 102. The distance 124 between the first panel 120 and the second panel 122 provides clearance, such that the guide wheel 110 is free from direct attachment with each of the first panel 120 and the second panel 122. In some non-limiting examples, the panels 120, 122 may comprise an acrylic, vinyl, or other plastic material, metal, glass, or wood. Additionally or alternatively, the panels 120, 122 may comprise a transparent material, such that an operator of the wire buffer system 10 may easily view the guide wheel 110 and the wire 12 within the frame 102.

Referring now to FIGS. 5A-5C, the wire buffer assembly 100 is illustrated in various states of operation. As mentioned above, the guide wheel 110 is suspended within the frame 102 between the first panel 120 and the second panel 122 via the wire 12. The guide pins 112 extend from the first panel 120 to the second panel 122 to define the wire path 12a between the top portion 102a of the frame 102 and the bottom portion 102b of the frame 102. The guide wheel 110 is configured to move upwards and downwards (i.e., between the raised position 110a and the lowered position 110b) in response to a length and/or tension of the wire 12, such that the guide wheel 110 may move along the wire path 12a within the frame 102.

The wire path 12a may be defined from the first opening 104, within a portion of the channel 116 of the guide wheel 12 to the second opening 106. As mentioned above, the guide pins 112 define the wire path 12a. For example, the wire 12 is fed from the first opening 104 along the wire path 12a defined by the guide pins 112 into the channel 116 of the guide wheel 110 to the second opening 106 following the guide pins 112. Segments of the wire 12 are continuously drawn from the dispenser 20, through the wire buffer assembly 100 to the tool head 16 of the automated tool 14 during operation of the wire buffer system 10. For example, the motor 22 draws the wire 12 from the dispenser 20 through the first opening 104 at a predetermined rate, and the guide wheel 110 assists in feeding the wire 12 to the tool head 16. The guide wheel 110 maintains the wire path 12a of the wire 12 and is utilized by the wire buffer system 10 to detect an error or other potential issue with the wire 12 inside the dispenser 20, described in more detail below. When the feed of the wire 12 is unimpeded, gravitational force acting on the guide wheel 110 draws the wire 12 proximate to the bottom portion 102b of the frame 102, depicted in FIG. 5A. A weight of the guide wheel 110 may be based, at least in part, on the gauge, tensile strength, and/or ductility of the wire 12. For example, the weight of the guide wheel 110 may be sufficiently heavy as to draw the wire 12 proximate to the bottom portion 102b of the frame 102 and may be sufficiently light as to prevent the guide wheel 110 from severing the wire 12.

With further reference to FIGS. 5A-5C, the wire 12 may twist, tangle, snag, or otherwise become impeded as the wire 12 is withdrawn from the dispenser 20 by the motor 22. As a result, the wire 12 may stop feeding from the dispenser 20 into the wire buffer system 10. During such a stoppage, the automated tool 14 may continue to draw the wire 12 from the second opening 106 of the wire buffer assembly 100. Accordingly, a respective segment of the wire 12 within the frame 102 pulls the guide wheel 110 upward toward the top portion 102a of the frame 102, as the respective segment of the wire 12 is drawn from the second opening 106, as depicted in FIGS. 5B and 5C.

As mentioned above, the plurality of sensors 108 of the wire buffer assembly 100 include guide wheel sensors 108a-108c configured to detect a position (i.e., the raised position 110a and the lowered position 110b) of the guide wheel 110 within the frame 102, which may inform a state of the wire 12. The operation software 30 of the controller 24 is configured to identify sensor data 130, 130a-130c from each respective guide wheel sensor 108a-108c and issue, in response, a respective notification 32. The notification 32 may indicate an associated error. For example, the notification 32 may indicate an error with the wire 12 at the dispenser 20 and/or an error with one or more of the guide wheel sensors 108a-108c.

A first guide wheel sensor 108a is disposed proximate to the bottom portion 102b of the frame 102 and is configured to detect the raised position 110a of the guide wheel 110. The raised position 110a may be defined by the guide wheel 110 being positioned above the first guide wheel sensor 108a. The lowered position 110b may be defined by the guide wheel 110 being positioned beneath the first guide wheel sensor 108a proximate to the bottom portion 102b of the frame 102. The first guide wheel sensor 108a is configured to assist the wire buffer system 10 in controlling a fill level of the wire 12.

The first guide wheel sensor 108a is configured to send sensor data 130, 130a, associated with the positions 110a, 110b of the guide wheel 110, to the controller 24. For example, if the first guide wheel sensor 108 detects the guide wheel 110 in the raised position 110a for a first predetermined period of time 132a, then the first guide wheel sensor 108a sends the sensor data 130, 130a to the controller 24 indicating the raised position 110a of the guide wheel 110. In response, the controller 24 may activate the motor 22 to feed more wire 12 from the dispenser 20 into the frame 102. For example, the first predetermined period of time 132a may be approximately one (1) millisecond, approximately ten (10) milliseconds, approximately 0.25 seconds, approximately 0.5 seconds, approximately one (1) second, and/or approximately two (2) seconds depending on the configuration of the controller 24. The controller 24 may also be programmed and reprogrammed to adjust the first predetermined period of time 132a based on a manufacturing project utilizing the wire buffer system 10, such that the first predetermined period of time 132a may be customized. As a result, the wire buffer assembly 100 continuously maintains a segment of wire 12 at least as long as a length of a braze joint.

When the first guide wheel sensor 108a detects the guide wheel 110 in the lowered position for a second predetermined period of time 132b, the controller 24 stops the motor 22. For example, the second predetermined period of time 132b may be approximately one (1) millisecond, approximately ten (10) milliseconds, approximately 0.25 seconds, approximately 0.5 seconds, approximately one (1) second, and/or approximately two (2) seconds, depending on the configuration of the controller 24. Like with the first predetermined period of time 132a, the second predetermined period of time 132b may be customized by programming and/or reprogramming the controller 24. The motor 22 is prevented from feeding an excess of wire 12 into the wire buffer assembly 100 by the controller 24 stopping the motor 22 in response to the detected lowered position 110b of the guide wheel 110 for the second period of time 132b.

For example, excess wire 12 in the wire buffer assembly 100 may cause the guide wheel 110 to rest on or near the bottom portion 102b of the frame 102 in the lowered position 110b, resulting in slack in the wire 12. The slack in the wire 12 indicates that there is a sufficient amount of wire 12 within the wire buffer assembly 100, such that additional wire 12 can be withheld until the first guide wheel sensor 108a detects the guide wheel 110 in the raised position 110a for the first period of time 132a. Thus, the first guide wheel sensor 108a provides sensor monitoring of the wire 12 in the wire buffer assembly 100 by monitoring the position 110a, 110b of the guide wheel 110. The position 110a, 110b of the guide wheel 110 is directly proportional to the amount of wire 12 within the wire buffer assembly 100, such that an error with the wire 12 within the dispenser 20 may be detected based on the position 110a, 110b of the guide wheel 110. The error may correspond to the guide wheel 110 being in the raised position 110a for the first predetermined period of time 132a, and the controller 24 may issue a notification 32 to check the dispenser 20 in response to the sensor data 130, 130a received from the first guide wheel sensor 108a.

With further reference to FIGS. 5A-5C, the plurality of sensors 108 also include a second guide wheel sensor 108b and a third guide wheel sensor 108c, which are configured as back-up or fail-safe sensors for the first guide wheel sensor 108a. For example, the second guide wheel sensor 108b and the third guide wheel sensor 108c are configured to detect the guide wheel 110 and provide sensor data 130, 130b, 130c to the controller 24. Rather than detecting the raised position 110a and the lowered position 110b of the guide wheel 110 like the first guide wheel sensor 108a, the second and third guide wheel sensors 108b, 108c are configured to detect the guide wheel 110 irrespective of the position. For example, the second guide wheel sensor 108b is disposed between the first guide wheel sensor 108a and the third guide wheel sensor 108c.

The second guide wheel sensor 108b is configured to detect that the guide wheel 110 is between the second guide wheel sensor 108b and the top portion 102a of the frame 102, as illustrated in FIG. 5B. The second guide wheel sensor 108b is located at a distance from the top portion 102a of the frame 102. A snag, tangle, or other obstruction may stop the wire 12 from feeding into the wire buffer assembly 100. Because the obstruction prevents the motor 22 from feeding the wire 12 into the wire buffer assembly 100, the wire 12 pulls the guide wheel 110 upwardly toward to the top portion 102a of the frame 102 as the automated tool 14 continues to withdraw wire from the second opening 106 of the wire buffer assembly 100.

The second guide wheel sensor 108b detects the guide wheel 110 as the guide wheel 110 travels toward the top portion 102a of the frame 102 and sends sensor data 130, 130b to the controller 24. In response, the controller 24 signals to the automated tool 14 to cease operation after completing an operating cycle but before the wire 12 in the wire buffer assembly 100 is exhausted (i.e., to complete the operating cycle that the automated tool 14 is currently performing and stop before beginning a new operating cycle). The automated tool 14 can complete the operating cycle when the segment of wire 12 in the wire path 12a is sufficiently long for the automated tool 14 to complete one operating cycle, which is determined based on a position of the guide wheel 110 within the frame 102, as detected by the second guide wheel sensor 108b. Thus, the wire buffer assembly 100 prevents abrupt stoppages in the operation of the automated tool 14 that may cause defects in brazing and lead to the discarding of components or raw materials.

Additionally, the second guide wheel sensor 108b serves as a secondary, backup monitor should the first guide wheel sensor 108a fail to detect the raised position 110a of the guide wheel 110. If the guide wheel 110 is detected by the second guide wheel sensor 108b, then the controller 24 is notified, via the sensor data 130, 130b, of an error in the wire buffer assembly 100. The error may be a result of the first guide wheel sensor 108a not detecting the raised position 110a of the guide wheel 110 resulting in the guide wheel 110 being detected by the second guide wheel sensor 108a. Thus, the controller 24 signals to the automated tool 14 to stop after completing one operating cycle (i.e., to complete the operating cycle that the automated tool 14 is currently performing and stop before beginning a new operating cycle).

For example, the guide wheel 110 is likely only detected by the second guide wheel sensor 108b if there is an error (i.e., snag, tangle, etc.) with the wire 12 at the dispenser 20 or a failure of the first guide wheel sensor 108a. In response, the controller 24, based on receiving sensor data 130b from the second guide wheel sensor 108b indicating detection of the guide wheel 110, signals to the automated tool 14 to cease operation after completing an operating cycle but before the wire 12 in the wire buffer assembly 100 is exhausted. Thus, the wire buffer assembly 100 prevents abrupt stoppages in the operation of the automated tool 14 that may cause defects in brazing and lead to the discarding of components or raw materials.

Referring still to FIGS. 5A-5C, the third guide wheel sensor 108c is disposed proximate to the top portion 102a of the frame 102. The third guide wheel sensor 108c is configured to detect that the guide wheel 110 is between the third guide wheel sensor 108c and the top portion 102a of the frame 102, as illustrated in FIG. 5C. By detecting when the guide wheel 110 is proximate to the top portion 102a of the frame 102, the third guide wheel sensor 108c detects that the wire buffer assembly 100 has an insufficient length of wire 12 in the wire path 12a for the automated tool 14 to complete a current operating cycle. In response, the controller 24 signals to the automated tool 14 to stop performing the current operating cycle.

Similar to the second guide wheel sensor 108b, the third guide wheel sensor 108c serves as a back-up or fail-safe sensor in the event that either the second guide wheel sensor 108b fails or both the first guide wheel sensor 108a and the second guide wheel sensor 108b fail. Accordingly, when a snag, tangle or other impedance stops the wire 12 from feeding into the wire buffer assembly 100, the third guide wheel sensor 108c may detect the guide wheel 110 and send sensor data 130, 130c to the controller 24. In response, the controller 24 signals to the automated tool 14 to cease operation immediately, preventing damage to the automated tool 14 or the wire buffer assembly 100 as a result of the impedance of the wire 12.

Referring again to FIGS. 1-5C, the wire buffer system 10 provides automated monitoring of wire 12 fed into the wire buffer assembly 100. The suspended guide wheel 110 and the respective guide wheel sensors 108a-108c provide information pertaining to a state of the wire 12 that may impact the operative function of the automated tool 14. The controller 24 monitors the sensor data 130, 130a-130c to detect whether to stop operations at the automated tool 14. The suspension of the guide wheel 110 by the wire 12 provides direct feedback as to a length of the wire 12 and the resultant state of the wire 12 within the dispenser 20. Thus, the wire buffer system 10 may automatically detect an error with the wire 12 based on the position 110a, 110b and detection of the guide wheel 110 within the frame 102.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A wire buffer assembly comprising:
a frame including a top portion defining a first opening and a second opening;
a guide wheel disposed within the frame;
a plurality of guide pins disposed within the frame and disposed around the guide wheel; and
at least one sensor disposed proximate to the guide wheel and configured to detect a position of the guide wheel within the frame.

2. The wire buffer assembly of claim 1, further comprising a motor disposed at the first opening.

3. The wire buffer assembly of claim 2, wherein the at least one sensor includes a first guide wheel sensor disposed proximate to a bottom portion of the frame, the first guide wheel sensor configured to detect a first position of the guide wheel defined above the first guide wheel sensor.

4. The wire buffer assembly of claim 3, wherein the at least one sensor includes a second guide wheel sensor disposed between the first guide wheel sensor and the top portion of the frame, the second guide wheel sensor configured to detect a second position of the guide wheel defined between the second guide wheel sensor and the top portion of the frame.

5. The wire buffer assembly of claim 4, wherein the at least one sensor includes a third guide wheel sensor disposed proximate to the top portion of the frame, the third guide wheel sensor configured to detect a third position of the guide wheel defined between the third guide wheel sensor and the top portion of the frame.

6. The wire buffer assembly of claim 5, wherein the at least one sensor includes a wire feed sensor disposed at the top portion of the frame, the wire feed sensor configured to detect a wire in the frame.

7. The wire buffer assembly of claim 1, wherein each of the at least one sensor includes at least one of a photoelectric sensor, a Hall effect sensor, an inductive sensor, and an ultrasonic sensor.

8. The wire buffer assembly of claim 1, further comprising a first panel coupled to the frame and a second panel coupled to the frame.

9. The wire buffer assembly of claim 8, wherein the plurality of guide pins extend from the first panel to the second panel.

10. The wire buffer assembly of claim 8, wherein the guide wheel is suspended within the frame between the first panel and the second panel, the guide wheel being free from direct attachment with each of the frame, the first panel, and the second panel.

11. The wire buffer assembly of claim 1, wherein the guide wheel includes a channel defined along a circumference of the guide wheel.

12. A wire buffer system comprising:
a wire buffer assembly configured to receive a wire, the wire buffer assembly including:
a frame including a top portion defining a first opening and a second opening, the wire received by the frame at the first opening;
a guide wheel disposed within the frame and having a raised position and a lowered position, the wire operably coupled to the guide wheel;
a motor coupled to the frame and disposed at the first opening; and
a first guide wheel sensor disposed proximate to a bottom portion of the frame, the first guide wheel sensor configured to detect one of the raised position and the lowered position of the guide wheel within the frame;
an automated tool configured to receive the wire from the second opening of the frame; and
a controller communicatively coupled with the automated tool, the controller including:
data processing hardware; and
memory hardware in communication with the data processing hardware, the memory hardware storing instructions that when executed on the data processing hardware cause the data processing hardware to perform operations comprising:
activating the motor in response to the first guide wheel sensor detecting the guide wheel in the raised position for a first predetermined period of time, the raised position defined by the guide wheel being positioned above the first guide wheel sensor; and
stopping the motor when the first guide wheel sensor detects the guide wheel in the lowered position, the lowered position defined by the guide wheel being positioned beneath the first guide wheel sensor proximate to the bottom portion of the frame for a second predetermined period of time.

13. The wire buffer system of claim 12, further comprising a second guide wheel sensor disposed between the first guide wheel sensor and the top portion of the frame, the second guide wheel sensor configured to detect that the guide wheel is between the second guide wheel sensor and the top portion of the frame.

14. The wire buffer system of claim 13, wherein the operations include stopping the automated tool when the second guide wheel sensor detects the guide wheel between the second guide wheel sensor and the top portion of the frame.

15. The wire buffer system of claim 14, further comprising a third guide wheel sensor disposed proximate to the top portion of the frame, the third guide wheel sensor configured to detect that the guide wheel is between the third guide wheel sensor and the top portion of the frame.

16. The wire buffer system of claim 15, wherein the operations include stopping the automated tool when the third guide wheel sensor detects that the guide wheel is between the third guide wheel sensor and the top portion of the frame.

17. The wire buffer system of claim 16, further comprising a wire feed sensor disposed at the top portion of the frame, the wire feed sensor configured to detect the wire received by the frame.

18. The wire buffer system of claim 17, wherein the operations include selectively activating the motor when the wire feed sensor detects the wire.

19. The wire buffer system of claim 17, wherein each of the first guide wheel sensor, the second guide wheel sensor, the third guide wheel sensor, and the wire feed sensor include at least one of a photoelectric sensor, a Hall effect sensor, an inductive sensor, and an ultrasonic sensor.

20. A wire buffer system comprising:
a wire buffer assembly configured to receive a wire, the wire buffer assembly including:
a frame including a top portion defining a first opening and a second opening, the wire received by the frame at the first opening;
a guide wheel disposed within the frame and having a raised position and a lowered position, the wire operably coupled to the guide wheel;
a motor coupled to the frame and disposed at the first opening;
a first guide wheel sensor disposed proximate to a bottom portion of the frame, the first guide wheel sensor configured to detect one of the raised position and the lowered position of the guide wheel within the frame;
a second guide wheel sensor disposed between the first guide wheel sensor and the top portion of the frame, the second guide wheel sensor configured to detect that the guide wheel is between the second guide wheel sensor and the top portion of the frame;
a third guide wheel sensor disposed proximate to the top portion of the frame, the third guide wheel sensor configured to detect that the guide wheel is between the third guide wheel sensor and the top portion of the frame; and
a wire feed sensor disposed at the top portion of the frame, the wire feed sensor configured to detect the wire received by the frame;
an automated tool configured to receive the wire from the second opening of the frame; and
a controller communicatively coupled with the automated tool, the controller including:
data processing hardware; and
memory hardware in communication with the data processing hardware, the memory hardware storing instructions that when executed on the data processing hardware cause the data processing hardware to perform operations comprising:
selectively activating the motor when the wire feed sensor detects the wire;
activating the motor in response to the first guide wheel sensor detecting the guide wheel in the raised position for a first predetermined period of time, the raised position defined by the guide wheel being positioned above the first guide wheel sensor;
stopping the motor when the first guide wheel sensor detects the guide wheel in the lowered position, the lowered position defined by the guide wheel being positioned beneath the first guide wheel sensor proximate to the bottom portion of the frame for a second predetermined period of time;
stopping the automated tool when the second guide wheel sensor detects the guide wheel between the second guide wheel sensor and the top portion of the frame; and
stopping the automated tool when the third guide wheel sensor detects that the guide wheel is between the third guide wheel sensor and the top portion of the frame.
